(19) United States
(12) Patent Application Publication
(10) Pub. No.: US 2020/0202614 A1
(43) Pub. Date: Jun. 25, 2020

(54) System, Method and Apparatus for a Space Modeling Tool

(71) Applicant: Omni Consumer Products, LLC, Addison, TX (US)

(72) Inventors: Marc Allen Gilpin, Richardson, TX (US); Larry Don McNutt, Carrollton, TX (US)

(21) Appl. No.: 16/696,157

(22) Filed: Nov. 26, 2019

Related U.S. Application Data
(60) Provisional application No. 62/772,606, filed on Nov. 28, 2018.

(51) Int. Cl. G06T 17/00; G06F 3/0481; G06F 3/0487

(52) U.S. Cl. CPC G06T 17/00; G06F 3/0487; G06F 3/04815

(57) ABSTRACT

A space modeling method, apparatus and system. The system includes a space modeling system, comprising: a space modeling apparatus, a display space, frame-work options module, aspects module, wherein the space modeling apparatus utilizes the frame-work options module and the aspect module to design a model and present the model in the display space.

### CROSS REFERENCE TO RELATED APPLICATIONS

This application claims benefit and priority from U.S. Provisional Application No. 62/772,606 filed on Nov. 28, 2018. The above identified patent applications are incorporated herein by reference in their entirety to provide continuity of disclosure.

### FIELD OF THE INVENTION

The disclosure relates to systems, apparatus and methods for creating and interacting with a life size living and working space model. More specifically, this disclosure relates to a life size space that is customizable “on the fly”, in real time, and capable of interacting with a person, a device, touch, etc.

### BACKGROUND OF THE INVENTION

It is preferable that a space model reflects a building or a room design. Currently, the designs are usually in 3D miniature models or on a screen display that simulates a small version of the model. However, these tools are limited in use and do not allow for experiencing the real design in its full potential. Therefore, there is a need for an improved system, apparatus and method for a space modeling tool.

### SUMMARY OF THE INVENTION

Embodiments described herein relate to a space modeling method, apparatus and system. The system includes a space modeling system, comprising: a space modeling apparatus, a display space, frame-work options module, aspects module, wherein the space modeling apparatus utilizes the frame-work options module and the aspect module to design a model and present the model in the display space.

### BRIEF DESCRIPTION OF DRAWINGS

Reference will now be made to the following drawings:

FIG. 1 is a block diagram illustrating an embodiment of a space modeling apparatus;

FIG. 2 is a diagram illustrating an embodiment of a space modeling system; and

FIG. 3 is a flow diagram illustrating an embodiment of a space modeling method.

### DETAILED DESCRIPTION

In the descriptions that follow, like parts are marked throughout the specification and drawings with the same numerals, respectively. The drawing figures are not necessarily drawn to scale and certain figures may be shown in exaggerated or generalized form in the interest of clarity and conciseness.

It will be appreciated by those skilled in the art that aspects of the present disclosure may be illustrated and described herein in any of a number of patentable classes or context including any new and useful process, machine, manufacture, or composition of matter, or any new and useful improvement thereof. Therefore, aspects of the present disclosure may be implemented entirely in hardware or combining software and hardware implementation that may all generally be referred to herein as a “circuit,” “module,” “component,” or “system” (including firmware, resident software, micro-code, etc.). Further, aspects of the present disclosure may take the form of a computer program product embodied in one or more computer readable media having computer readable program code embodied thereon.

Aspects of the present disclosure are described herein with reference to flowchart illustrations and/or block diagrams of methods, systems and computer program products according to embodiments of the disclosure. It will be understood that each block of the flowchart illustrations and/or block diagrams, and combinations of blocks in the flowchart illustrations and/or block diagrams, can be implemented by computer program instructions, hardware or a combination thereof. It is also understood that not all the elements listed are required and that the order specified is only by way of example.

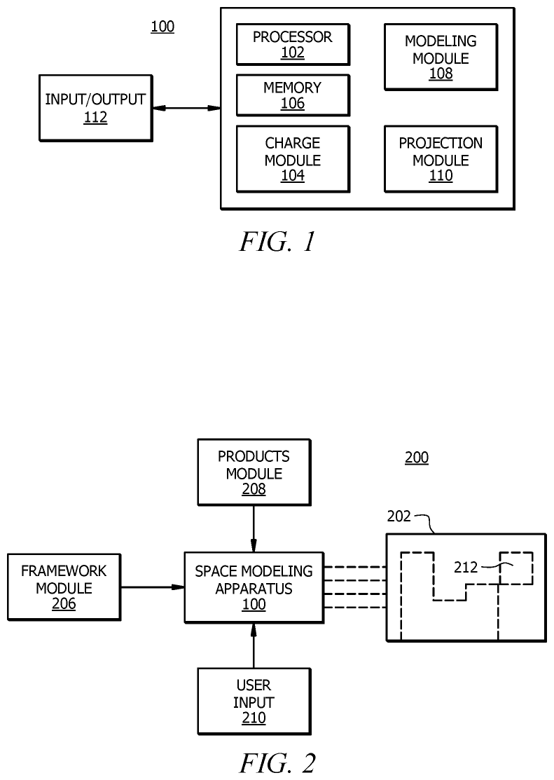

FIG. 1 is a block diagram illustrating an embodiment of a space modeling apparatus 100. The space modeling apparatus 100 is used to design, present and/or alter life size space models. The space models may be a life size model of a kitchen, office, yard, etc. The space modeling apparatus 100 comprises a processor (CPU) 102, a charge module 104, memory 106, modeling module 108, projection module 110, and input/output devices (I/O) 112.

Memory 106 may be any combination of one or more computer readable media. The computer readable media may be a computer readable signal medium, any type of memory or a computer readable non-transitory storage medium. For example, a computer readable storage medium may be, but not limited to, an electronic, magnetic, optical, electromagnetic, or semiconductor system, apparatus, or device, or any suitable combination of the foregoing. More specific examples of the computer readable storage medium would include, but are not limited to: a portable computer diskette, a hard disk, a random access memory (“RAM”), a read-only memory (“ROM”), an erasable programmable read-only memory (“EPROM” or Flash memory), an appropriate optical fiber with a repeater, a portable compact disc read-only memory (“CD-ROM”), an optical storage device, a magnetic storage device, or any suitable combination of the foregoing. Thus, a computer readable storage medium may be any tangible medium that can contain or store a program for use by or in connection with an instruction execution system, apparatus, or device.

Computer program code for carrying out operations utilizing a processor or CPU 102 for aspects of the present disclosure may be written in any combination of one or more programming languages, markup languages, style sheets and JavaScript libraries, including but not limited to Windows Presentation Foundation (WPF), HTML/CSS, XAML, and JQuery, C, Basic, *Ada, Python, C++, C#, Pascal, *Arduino, JAVA and the likes. Additionally, operations can be carried out using any variety of compiler available.

The computer program instructions on memory 106 may be provided to a processor 102, where the processor 102 is of a general purpose computer, special purpose computer, microchip or any other programmable data processing apparatus to produce a machine, such that the instructions, which execute via the processor of the computer or other programmable instruction execution apparatus, create a mechanism for implementing the functions/acts specified in the flowchart and/or block diagram block or blocks. The computer instructions may do one or more of the following, run the space modeling apparatus 100, give status or health of the space modeling apparatus 100 or the entire system utilizing the space modeling apparatus 100. In one embodiment, it may even perform image analysis and/or perform data compression.

These computer program instructions may also be stored in memory 106 (computer readable medium) that when executed can direct a computer, processor, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, processor, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The charge module 104 is utilized to power/maintain power to the space modeling apparatus 100. The charge module 104 may be wired or wireless and may utilize one or combination of the following battery, WIFI charging, coil, solar cells, or any other mechanism that provides charge to the space modeling apparatus 100.

The modeling module 108 utilizes data in memory or in a database available on I/O 112. The modeling module 108 is used to build a frame-work of a space using option in the data. In other words, the frame-work module is capable of utilizing one or more aspect from a single data set, manufacturer or distributer and another one or more aspects from another data set, manufacturer or distributer. In one embodiment, the frame-work is extracted from a photo or a digital image. The modeling module 108 also uses aspects data that may be available via memory 106 and/or I/O device(s) 112. The aspects are selected based on preference. In one embodiment, the aspects may be selected from various vendors databases or data. Thus, when selecting aspects for a frame-work, the use may be able to select various aspects from one vendor for flooring and different aspects from another vendor for counters.

For example, the frame-work may be that of a kitchen with 3 cabinets, 2 counter tops, an over and a window. The aspects are then added to show the counters in different granite colors, different wall colors, various cabinet designs and colors, etc. The aspects may vary in the same model and are changeable “on the fly”, in real-time. The designs frame-work and selected aspects are then displayed in life size using the projection module 110. The projection module 110 may display on a white wall the entire frame-work with the aspects, where various items displayed are interactive in the life size model. As such, a user may be able to trigger the opening and closing cabinet of cabinets in the projected life size model. Yet in another aspect, the life size model is a 3-dimensional model and/or may be rotatable to show different angles of the model.

The I/O 112 may be any devices that are used to present, print, receive, store, analyze, transmit, communicate, etc. with the space modeling apparatus 100. The I/O 112 may be coupled wirelessly or with a wire with the space modeling apparatus 100.

FIG. 2 is a diagram illustrating an embodiment of a space modeling system 200. The space modeling system 200 comprises the space modeling apparatus 100 as described in FIG. 1, a display space 202, frame-work options module 206, aspects module 208, user input 210 and a displayed model 212. The display space 202 may be a presentation of an outdoor scene, a white wall, an architectural display, etc. The display space 202 creates the back drop for the displayed model 212. The frame-work module 206 is used to create a frame-work that outlines the “neutral” form of the model. These “neutral” form of the model alters in shape, color, design utilizing aspects from the aspect module 208.

For example, the frame-work module 206 may contain data and design of kitchen cabinets, walls, windows, etc. These items are them altered in shape utilizing aspects from the aspect module 208. As such, the frame-work designed using the frame-work module 206 changes its color, materials, etc. based on the aspects selected in the aspect module 208. In one embodiment, a photo or a diagram is entered into the frame-work module 206 or the aspect module 208 and used in the selection process to design a model.

Once a model is designed in the space modeling apparatus 100, the model 212 is projected over or into the display space 202. The model 212 may be a 2-dimensional and/or a 3-dimentinal model. The model 212 may change aspects in real time. Also, aspects of the model 212 may be partially changed to allow for comparison of 2 different aspects. The model 212 may be an interactive. Thus, the model 212 may allow a user to select various items in the model 212 and watch the item change, do something, make a noise, etc.

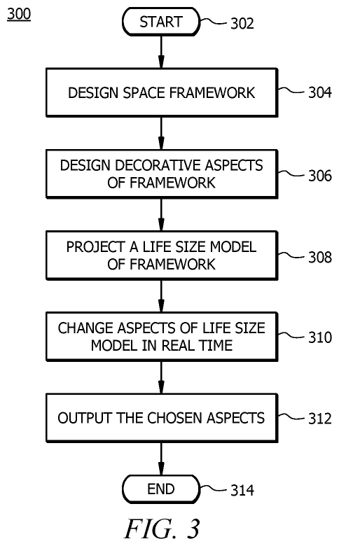

FIG. 3 is a flow diagram illustrating an embodiment of a space modeling method 300. The space modeling 300 starts at step 302 and proceeds to step 304. At step 304, the method 300 designs space frame-work(s). At step 306, the method 300 designs decorative aspects of the frame-work. At step 308, the method 300 projects a life size model of the frame-work. At step 310, the method 300 changes aspects pf the life size model in real-time. In some embodiments, the method 300 outputs the design model, i.e., prints the model, email the chosen aspects list, orders the chosen aspects, etc. The method 300 ends at step 314.

It will be appreciated by those skilled in the art that changes could be made to the embodiments described above without departing from the broad inventive concept. It is understood, therefore, that this disclosure is not limited to the particular embodiments herein, but it is intended to cover modifications within the spirit and scope of the present disclosure as defined by the appended claims.

What is claimed is:

1. A space modeling system for depicting a life size representation of a design, comprising:
a space modeling apparatus, wherein the space modeling apparatus utilizes a processor to design, present and alter a space model;
a frame-work options module;
an aspect module, wherein the space modeling apparatus utilizes the frame-work options module and the aspect module to design a model and displays the model in the display space in life size.

2. A space modeling system of claim 1, wherein the frame-work module is capable of utilizing one or more aspects of a data set in combination with one or more aspects of another data set.

3. A space modeling system of claim 2, wherein one data set relates of at least one of a manufacturer and distributor and the other set to at least one different manufacturer or distributor.

4. A space modeling system of claim 1, wherein the aspect module presents various shapes, sizes, colors, lighting-effects and textures.

5. A space modeling system of claim 1, wherein the aspect module changes the display in the display space on the fly or in real-time.

6. A space modeling system of claim 1, wherein the display in the display space is interactive.

7. A space modeling system of claim 1, wherein the life size model is in at least one of 2-dimensional or 3-dimensional.

8. A space modeling system of claim 1, wherein the display space is at least one of in-doors or out-doors.

9. A space modeling method for displaying a life-size model in a display space, the method comprising:
designing a space frame-work;
choosing design aspects of the display;
projecting a life-size model of he frame-work, wherein the life-size aspect is at leas one of 2-dimensional or 3-dimensional; and
change aspects of the life size model in real-time to decide of aspect preferences.
